(19) United States
(12) Patent Application Publication
(10) Pub. No.: US 2009/0073322 A1
(43) Pub. Date: Mar. 19, 2009

(54) DIGITAL BROADCAST RECEIVER

(75) Inventors: Akihito Shibahara, Kanagawa (JP); Tadahisa Kitajima, Kanagawa (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/206,097

(22) Filed: Sep. 8, 2008

(30) Foreign Application Priority Data
Sep. 14, 2007 (JP) 2007-239798

(51) Int. Cl. H04N 5/455

(52) U.S. Cl. 348/726; 348/E05.113

(57) ABSTRACT

A data separating section separates stream data demodulated by a signal demodulating section, into video data and other data. A pattern comparison processing section performs pattern comparison between a specific object included as an image in the video data decoded by a decoding section, on a screen, and comparison source image data included in the other data, and generates position information on the specific object on the screen. A data processing section uses the position information from the pattern comparison processing section to output display information data which enables display data related to the specific object to be displayed in accordance with a position of the specific object.

### CROSS REFERENCE TO RELATED APPLICATION

This application is based upon and claims the benefit of priority from the prior Japanese Patent Application No. 2007-239798 filed on Sep. 14, 2007; the entire contents of which are incorporated herein by reference.

### BACKGROUND OF THE INVENTION

1. Field of the Invention

The present invention relates to a digital broadcast receiver which can perform pattern detection or the like for a specific image on a broadcast screen, automatically attach and display information related to the image, near the specific image.

2. Description of the Related Art

Conventionally, in TV broadcasts including a digital TV broadcast, for a relay or the like of sports (for example, soccer and baseball) performed by many people in a large space, a relay broadcast on a screen configured to display a wide space including a central portion of a game, such as a position where a ball exists, (hereinafter referred to as “zoom out image”) may often be performed in order to make it easier to understand the tide of a match. Here, the zoom out image refers to a screen in a state where an entire field of a stadium, for example, in a soccer match, can be seen.

In the present case, for a viewer watching the broadcast at a receiver, it is very easy to see the tide of the match itself. However, at the same time, individual players and the like are viewed in very small images, which make it difficult to distinguish among the individual players and the like. Thus, even if there has been an explanatory commentary or the like within the broadcast, it may be impossible to understand which player on the screen the commentary has been made for, or a wrong player may be watched or the like.

As conventional video equipment provided with a displaying device configured to display images, there has been a patent disclosing an information providing method in which, in a video playing device having video accumulating means, if a place corresponding to an individual player has been indicated in an enlarged video or during a slow play, information related to a target player thereof is presented (for example, see Japanese Patent Application Laid-Open Publication No. 2002-366418).

Moreover, there has also been a patent disclosing a superimposed display device in which, during reception of a data broadcast program, related information to be displayed for each object is determined from a position being pointed on a video and position information on the object, and the related information on the object is superimposed and displayed on the video (for example, see Japanese Patent Application Laid-Open Publication No. 2004-297448).

Furthermore, there has also been a patent disclosing a controlling device provided with an indicating section configured to indicate and operate a position on a video, and processing means configured to recognize a target object in the indicated and operated video and display information associated with the above described recognized target object (for example, see Japanese Patent Application Laid-Open Publication No. 2002-335518).

However, in any technique disclosed in Japanese Patent Application Laid-Open Publication No. 2002-366418, Japanese Patent Application Laid-Open Publication No. 2004-297448 and Japanese Patent Application Laid-Open Publication No. 2002-335518, when an operator who is a user hopes to know the information related to the target object in a screen being displayed, the operator needs to perform the operation and the indication with indicating means. For example, like a live broadcast of the soccer match, when a specific player is desired to be continuously followed in the screen of the zoom out image in which the field is viewed, it has been impossible to continue displaying a player name (or a mark) following a motion of the player.

In Japanese Patent Application Laid-Open Publication No. 2002-366418, it is necessary to previously accumulate information related to the individual players in a recording medium so that the information is linked to play statuses, which requires many preparations (time and efforts) of the user. With respect to a moving object (image) which is transmitted in real time from a content transmitting side such as a broadcast station, it has been impossible to display information related to the moving object (for example, a name) near the object so that a specific object can be easily confirmed.

### SUMMARY OF THE INVENTION

According to an aspect of the present invention, a digital broadcast receiver is provided, includes: a signal demodulating section configured to receive and demodulate a digital television broadcast signal including stream data having at least video data and other data, the latter of which includes display data to be displayed for a specific object included as an image within the video data and comparison source image data which has been separately prepared for identifying the object; a data separating section configured to separate the stream data demodulated by the signal demodulating section, into the video data and the other data; a decoding section configured to decode the video data separated by the data separating section; a pattern comparison processing section configured to perform pattern comparison between the specific object included as the image in the video data decoded by the decoding section, on a screen, and the comparison source image data included in the other data separated by the data separating section, and thereby generate position information on the specific object on the screen; and a data processing section configured to use the display data related to the specific object included in the other data separated by the data separating section and the position information generated by the pattern comparison processing section, to output display information data which enables the display data to be displayed in accordance with a position of the specific object on the screen.

### BRIEF DESCRIPTION OF THE DRAWINGS

FIG. 1 is a block diagram showing a digital broadcast receiver of a first embodiment of the present invention;

FIG. 2 is a diagram illustrating an example of a relationship among comparison source data, an identifier and display data;

FIG. 3 is a diagram showing a screen display example according to the first embodiment;

FIG. 4 is a block diagram showing the digital broadcast receiver of a second embodiment of the present invention;

FIG. 5 is a block diagram showing the digital broadcast receiver of a third embodiment of the present invention;

FIG. 6 is a diagram showing a state where a screen has been partitioned in a lattice pattern of a predetermined size;

FIG. 7 is a block diagram showing the digital broadcast receiver of a fourth embodiment of the present invention; and

FIG. 8 is a block diagram showing a conventional digital broadcast receiver.

### DETAILED DESCRIPTION OF THE PREFERRED EMBODIMENTS

Embodiments of the present invention will be described with reference to the drawings.

Before the embodiments of the present invention are described, a conventional art will be described with reference to FIG. 8.

As shown in FIG. 8, a conventional digital broadcast receiver 100 configured to receive a digital TV broadcast is provided with a signal demodulating section 101 configured to receive an RF signal of a TV broadcast wave having content composed of MPEG TS data including streams of video TS data S2 and audio TS data S3, and other TS data S4, which are being broadcasted, and convert the RF signal into MPEG TS data S1; a demultiplex processing section 102 as a data separating section configured to separate the MPEG TS data S1 into the video TS data S2, the audio TS data S3 and the other TS data S4; a video MPEG decoder 103 and an audio MPEG decoder 104 configured to restore the video TS data S2 and the audio TS data S3, which have been separated, respectively to original data; a data processing section 105 configured to process information based on user data or the like which has been attached to the other TS data S4 or each picture (=1 frame) in the video TS data S2 and is retrieved by the MPEG decoder 103 as a decoding section; a graphics processing section 106 configured to display onscreen (hereinafter “OSD”) information such as content of a data broadcast or an EPG (Electronic Program Guide) on a screen, based on the information from the data processing section 105 and a system controlling section 120; an output controlling section 107 configured to accept output from the MPEG decoders 103 and 104 and output from the graphics processing section 106, appropriately process the output, and output the output to an external device (an image outputting device such as a CRT or a liquid crystal panel, or an audio outputting device); and the system controlling section 120 which has an external input/output I/F and the like and is configured to control user operations or an entire system.

Such a digital broadcast receiver receives the TV broadcast wave having the content composed of the MPEG TS data including streams of video data, audio data and other data, which are transmitted as the digital TV broadcast, reproduces and displays the TV broadcast wave.

At the time, information related to an object (image) in the video TS stream or the like is included in a portion of the other TS data (SI data or independent PES data, in the case of an ARIB standard), analyzed by the data processing section of the receiver, and displayed as OSD data on the screen by the graphics processing section.

Thus, in the case of such a receiver, for example, like a zoom out image screen in a state where an entire field of a stadium in a soccer match can be seen, if a player in the screen is set as an intended object within the screen, in consideration of displaying information (for example, a name) to be displayed in accordance with a position of the intended object, position information on an arbitrary target object (player) or the like needs to be transmitted in a form in which the position information or the like has been previously included as information in the other TS data or the like, from a content data transmitting side (broadcast station).

However, in the case of the conventional art, as described above, if players move in a sports relay or the like, in such a case where the information related to the object such as the target player is continuously displayed at a nearest position to the position of the object, it is necessary for the content data transmitting side to continue transmission of the position information which has been changed in accordance with a motion of the object, in the form in which the position information is included in the other TS data or the like.

Therefore, in the case of a live relay or the like, if the motion of the player is random and cannot be predicted or the like, it practically becomes significantly difficult to simultaneously transmit the position information on the player.

Thus, in a current digital TV receiver, only for a screen in which the motion of the object is limited, such as on a still image, a scene with no motion or a replay screen, display of the related information is performed at the position of the object on the screen.

Thus, in the conventional art, it is difficult to display the related information or the like on a specific object, based on the position of the object on the screen, in real time in a relay screen of a live broadcast. The information related to the specific object is displayed at a specific position regardless of the position of the object on the screen during the broadcast. Therefore, it becomes necessary for a viewer to comprehend where the target object exists on the screen.

### First Embodiment

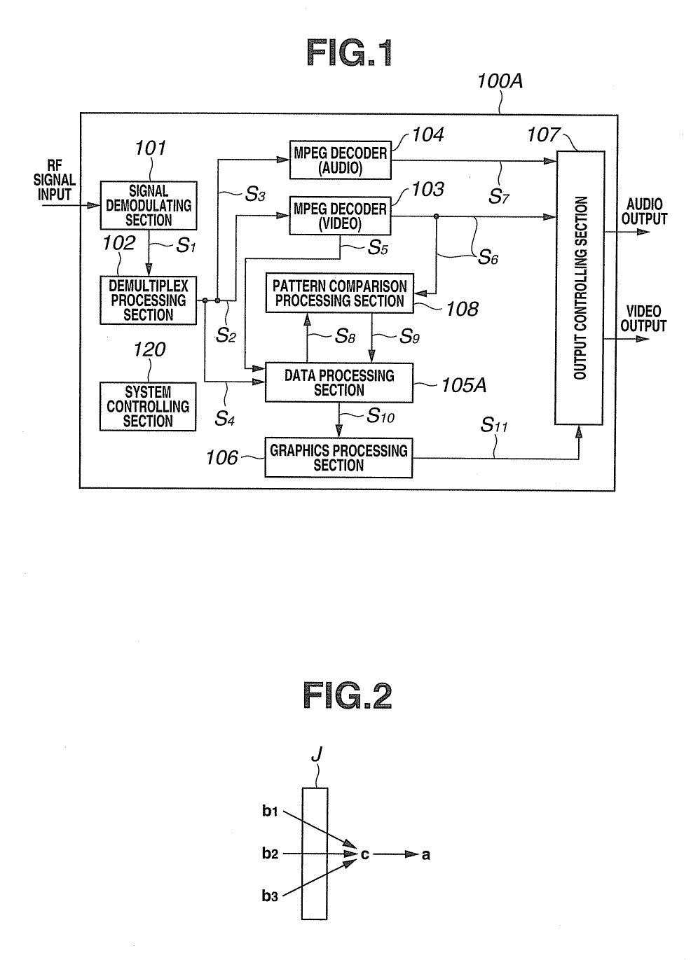

FIG. 1 shows a block diagram of a digital broadcast receiver of a first embodiment of the present invention. FIG. 1 has a configuration in which a pattern comparison processing section has been added to the conventional digital broadcast receiver of FIG. 8.

In FIG. 1, a digital broadcast receiver 100A is provided with a signal demodulating section 101, a demultiplex processing section 102, a video MPEG decoder 103 and an audio MPEG decoder 104, a data processing section 105A, a graphics processing section 106, an output controlling section 107, a pattern comparison processing section 108, and a system controlling section 120. Sections with the same functions as functions of FIG. 8 are attached with the same reference characters.

The signal demodulating section 101 receives the RF signal of the TV broadcast wave including content composed of stream data having the video TS data S2, the audio TS data S3, and the other TS data S4 which includes display data a such as the name related to the specific object included as an image within the video TS data S2 and comparison source image data (hereinafter simply referred to as “comparison source data”) b which has been previously prepared for identifying the object, as a digital television broadcast signal, and converts the digital television broadcast signal into the MPEG TS data S1.

The demultiplex processing section 102 as the data separating section separates the stream data demodulated by the signal demodulating section 101, into the video TS data S2, the audio TS data S3, and the other TS data S4.

The video and audio MPEG decoders 103 and 104 as the decoding section decode the video TS data S2 and the audio TS data S3 which have been separated by the demultiplex processing section 102, and output video data S6 and audio data S7.

The pattern comparison processing section 108 performs pattern comparison between the specific object included as the image in the video data S6 decoded by the MPEG decoder 103, on the screen, and the comparison source data which is included in the other TS data S4 separated by the demultiplex processing section 102 and is for identifying the specific object, and thereby generates position information on the specific object on the screen.

The data processing section 105A uses the display data related to the specific object included in the other TS data S4 separated by the demultiplex processing section 102 and the position information generated by the pattern comparison processing section 108, to output display information data S10 for displaying the display data in accordance with the position of the specific object on the screen.

In the above configuration, operations of the pattern comparison processing section 108 and the data processing section 105A will be mainly described.

In the digital broadcast receiver, in data of the broadcast wave from a broadcast transmitting side, as the other TS data denoted by reference character S4, data including the display data a of the related information to be displayed for the specific object included as the image within the video data S6 at the time of transmission, and the comparison source data b for identifying the specific object corresponding to the display data a from the image within the video data S6, is transmitted as content data of the digital broadcast.

Furthermore, on the receiver side, the data processing section 105A inputs “other TS data” denoted by reference character S4, and analyzes whether or not the comparison source data b for identifying the specific object is included in the other TS data S4. If the comparison source data b exists in the other TS data S4, the data processing section 105A generates the comparison source data b and an identifier c for the comparison source data b, and registers the comparison source data b and the identifier c in the pattern comparison processing section 108.

With respect to the identifier c, as will be described later in FIG. 2, if multiple pieces of characteristic data (for example, if the object is a person, characteristic data of his face, clothes, shoes and the like) for identifying the specific object have been prepared as the comparison source data b, when a predetermined number, which has been previously defined, of the multiple pieces of characteristic data matches characteristics of an object to be identified, the object to be identified is regarded as an intended object which has satisfied a necessary identification condition, and the identifier c indicating that the identification condition has been satisfied is generated. Then, the display data a which has been previously prepared in a manner corresponding to the identifier c can be determined. Data S8 which is outputted from the data processing section 105A and inputted to the pattern comparison processing section 108 is the comparison source data b for identifying the specific object and the identifier c thereof.

It should be noted that the data processing section 105A performs a process similar to the process performed by the conventional receiver (FIG. 8), for data other than the display data a, the comparison source data b and the identifier c included in the other TS data S4.

The pattern comparison processing section 108 captures a picture of the video data S6 (picture of MPEG) outputted from the MPEG decoder 103, as input, and performs a pattern matching process within an image of the picture data, with the comparison source data b registered at reference character S8. If a matching object has existed within the image of the picture data, the pattern comparison processing section 108 returns position information d indicating a coordinate position at which data matching the identifier c of matched comparison source data exists within the picture data, to the data processing section 105A. Reference character S9 denotes the position information d obtained as a result of image pattern comparison, and the identifier c of the comparison source data.

The data processing section 105A retrieves the information a to be displayed on the screen, from within data obtained in the other TS data S4, based on information on the identifier c obtained in reference character S9. The data processing section 105A processes the display data a as appropriate display data by using the position information d obtained in reference character S9, and subsequently outputs the appropriate display data as the display information data S10 to the graphics processing section 106.

If the display information data S10 has been transmitted, the graphics processing section 106 outputs the display information data S10 as OSD data S11 to the output controlling section 107. If the display information data S10 has not arrived, the OSD data S11 related thereto is not outputted.

The output controlling section 107 accepts the video data S6 and the audio data S7 from the MPEG decoders 103 and 104, and the OSD data S11 from the graphics processing section 106. The output controlling section 107 appropriately processes and supplies the video data S6, the audio data S7 and the OSD data S11 as video output and audio output to an external displaying device (not shown).

The above process is performed in a time period in which a video is being played.

FIG. 2 is a diagram illustrating an example of a relationship among the comparison source data b, the identifier c and the display data a.

In FIG. 2, reference characters b1, b2 and b3 denote multiple pieces (here, three) of the comparison source data b for identifying the specific object (for example, a player). As the three pieces of the comparison source data b1, b2 and b3, for example, in the case of a soccer player, three pieces of the characteristic data, such as a color of a uniform such as a T-shirt, the face of the player, and a shape of the shoes, have been previously prepared as the three pieces of the comparison source data for one watched player by the broadcast transmitting side. The three pieces of the comparison source data are included in the stream data, as the comparison source data b in the other TS data S4, along with the display data a (the name, a mark and the like of the player), and transmitted to the receiver side.

On the receiver side, in the data processing section 105A, the identifier c is generated based on a matching condition J for the multiple pieces of the comparison source data b included in the other TS data S4 which has been separated by the demultiplex processing section 102, and is registered in the pattern comparison processing section 108. Therefore, the identifier c is determined based on the condition J for the three pieces of the comparison source data b1, b2 and b3. The identifier c and the display data a have been linked to each other. Thus, when the identifier c is determined, the display data a is determined. The comparison source data b and the identifier c are linked to each other based on the condition J at the time of the generation of the identifier c. Content of the condition J is set by the system controlling section 120.

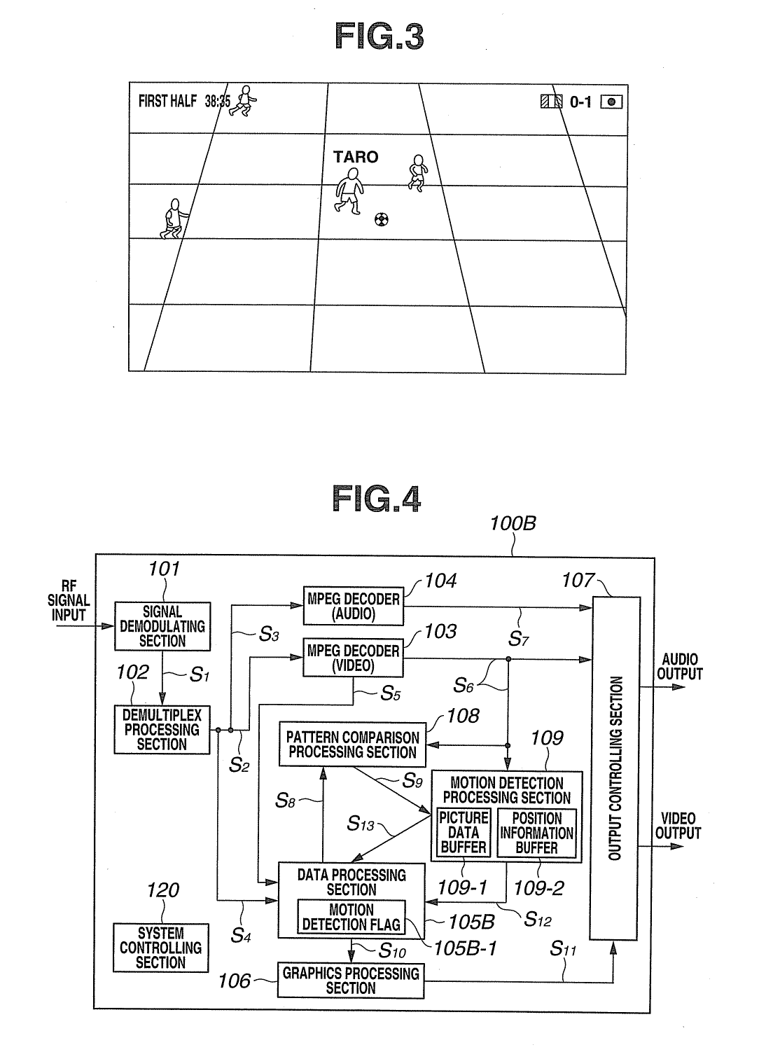

For example, under the condition J (corresponding to an OR condition) that it is regarded that pattern matching has been achieved if at least one piece of the comparison source data b1, b2 and b3 matches the object within the image of the picture data, if the pattern matching is performed respectively and any one of b1, b2 and b3 has matched, the identifier c is necessarily generated. The identifier c is regarded to satisfy one of three characteristics of the object (player), and the display data a is linked to the identifier c. As a result, the display data indicating, for example, the name, the mark and the like of the player is displayed near the player which is the object on the screen. For example, like a screen display example of FIG. 3, a player name of “Taro” is displayed near the player.

Alternatively, under the condition J that it is regarded that the pattern matching has been achieved if at least two pieces of the comparison source data b1, b2 and b3 match the object within the image of the picture data, if the pattern matching is performed respectively and the two pieces have matched, that is, if any two of b1, b2 and b3 have matched, the identifier c is necessarily generated. The identifier c is regarded to satisfy two of the three characteristics of the object (player), and the display data a is linked to the identifier c. As a result, the display data indicating, for example, the name, the mark and the like of the player is displayed near the player which is the object on the screen. According to the condition, the pattern matching with higher precision becomes possible.

Similarly, under the condition J (corresponding to an AND condition) that it is regarded that the pattern matching has been achieved if all of the three pieces of the comparison source data b1, b2 and b3 match the object within the image of the picture data, the pattern matching with the highest precision becomes possible.

It should be noted that a configuration may be included in which several conditions J for generating the identifier c are prepared as described above and the condition can be selected.

Moreover, the comparison source data b may be configured with one piece of the characteristic data. For example, the image pattern comparison can also be performed with a uniform number of the player as one piece of the comparison source data. Hereinafter, a case where data such as the player name is simultaneously displayed for each of multiple players on the screen will be described.

For example, if there are 15 players registered for a match and their uniform numbers are used as the comparison source data, the broadcast transmitting side prepares 15 different uniform numbers for identifying all of the 15 players respectively, as the comparison source data. The broadcast transmitting side includes 15 pieces of the comparison source data in the stream data, as the comparison source data b in the other TS data 4S, along with 15 pieces of the display data a (the name, the mark and the like of the player) corresponding to the 15 pieces of the comparison source data, and transmits the stream data to the receiver side.

On the receiver side, in the data processing section 105A, 15 identifiers c1 to c15, each of which one-to-one corresponds to each piece of comparison source data b1 to b15 of the respective 15 players, are generated and registered in the pattern comparison processing section 108. In the present case, since there is a one-to-one corresponding relationship, the 15 identifiers c1 to c15 may be exactly identical to the respective corresponding pieces of the comparison source data.

Then, on the receiver side, display data a1 to a15 and the respective comparison source data b1 to b15 are prepared for the 15 players (or may be prepared by capturing data transmitted from the broadcast transmitting side) so that a user can select several specific players (for example, five watched players) from among the 15 players on-screen displayed on a displaying device (not shown) by using operating means such as a remote controller to issue an instruction to the system controlling section 120. Of course, all the players can also be selected. At the time, the system controlling section 120 controls the data processing section 105A, the pattern comparison processing section 108 and the graphics processing section 106 to on-screen display a list of the players, or to perform control for generating necessary display information data based on the display data a and the position information d only on the selected specific players and displaying the display data for each object (image) on the screen, in response to the instruction for the selection with the operating means.

As described above, it is possible to display respective display data (player names) for multiple specific objects (players) near the respective objects, and enable the user to easily visually recognize the watched players.

Furthermore, as in the case of an intercollegiate relay road race or a relay road race among business groups, when there is a request for knowing a team name (a university name or a group name) rather than information on an individual player (the player name and the like), selection between displaying the team name and displaying the player name, near a running player, may be enabled. The selection may be performed by enabling capture of data related to the individual player and data related to each team which are transmitted from the broadcast transmitting side, into the receiver side, and selection of either the data related to the individual player or the data related to each team.

It should be noted that, when the pattern matching is performed in the pattern comparison processing section 108, as an example of performing the matching with the higher precision by preparing the multiple pieces of the comparison source data instead of one piece of the comparison source data, if the multiple pieces of the comparison source data are prepared for the same person, of course, image data of the person in several poses (postures) has been preferably prepared as the comparison source data. The image data of the person in the several poses (postures) is particularly effective when the pattern matching is performed for a person in motion, such as an athlete.

According to the first embodiment, if the broadcast transmitting side has only transmitted the data a to be displayed for the arbitrary or specific object and the comparison source data b corresponding to the data a, the receiver side uses the pattern matching based on the data a and b, examines the position of the arbitrary or specific object on a reproduced screen based on the picture data in the video data S6 to be played, and accordingly displays the display data a for the object.

Thus, even if a watched object moves randomly as in the case of the live broadcast and the specific object exists at any position on the screen, the data a to be displayed at the position can be appropriately displayed.

As a result, in the sports relay or the like on the screen as shown in FIG. 3, when the watched object is the specific player, the comparison source data b for the identification is image data of the specific player, and the data a to be displayed is information on the name and the like of the player, even if the player has moved on the relay screen, the information on the position where the player exists can be appropriately obtained with the pattern matching whenever the data a is displayed. Therefore, the data a to be displayed can be displayed at a position where the player is being displayed. As a result, there is an advantage that information with which a viewer identifies the player is more appropriately presented, which enables the viewer to easily recognize the player.

In contrast to the conventional digital broadcast receiver, it becomes possible to display the information for the specific object in accordance with a position of a specific image (object) on the screen. As a result, there can be obtained an advantage that it becomes possible for the viewer to easily recognize which object the information obtained at the time of receiving the broadcast is for, and an advantage that it becomes possible for the viewer to easily confirm which position a specific object watched by the viewer exists at on the screen, and the like.

### Second Embodiment

FIG. 4 shows a block diagram of the digital broadcast receiver of a second embodiment of the present invention. FIG. 4 has a configuration in which a motion detection processing section has been added to the digital broadcast receiver of the first embodiment of FIG. 1.

In FIG. 4, a digital broadcast receiver 100B has a configuration provided with the signal demodulating section 101, the demultiplex processing section 102, the video MPEG decoder 103 and the audio MPEG decoder 104, a data processing section 105B, the graphics processing section 106, the output controlling section 107, the pattern comparison processing section 108, a motion detection processing section 109 and the system controlling section 120. Sections with the same functions as the functions of FIG. 1 are attached with the same reference characters.

The data processing section 105B has a motion detection flag 105B-1 therein, in addition to the functions of the first embodiment. While the flag is 0, from the inputted data S4, similarly to the first embodiment, the data processing section 105B outputs the output S8 which is the comparison source data b and the identifier c thereof to the pattern comparison processing section 108. The flag has an initial value of 0, and a flag value is set with an input value S13 from the motion detection processing section 109. Reference character S13 denotes a motion detection flag change value.

In the pattern comparison processing section 108, the data S8 is inputted, and the data S9 which is output similar to that of the first embodiment is outputted to the motion detection processing section 109. In the pattern comparison processing section 108, similarly to the first embodiment, the identifier c of the comparison source data is registered.

The motion detection processing section 109 is provided with a buffer 109-1 for the picture data in the video data S6, and a position information buffer 109-2. The motion detection processing section 109 retains picture data which has been inputted immediately before, in the picture data buffer 109-1, and retains the position information for the immediately previous picture data, in the position information buffer 109-2.

The motion detection processing section 109 is provided with a function configured to input the video data S6 decoded by the MPEG decoder 103 as the decoding section, detect an amount of movement (data on a direction and a distance) of the specific object between on a previous screen and on a current screen, generate new position information d′ in which the amount of movement has been added to the position information on the specific object on the previous screen, and supply the new position information d′ to the data processing section 105B.

In the motion detection processing section 109, a process is performed each time the picture data is inputted. If there is no input S9 from the paftern comparison processing section 108, the motion detection processing section 109 detects a shift of an image of a portion indicated by the position infonnation retained in the position information buffer 109-2, between the picture data in the picture data buffer 109-1 and the picture data which is newly inputted, generates an amount of movement (data on a direction and a distance) between images, and outputs updated position information d′ generated by adding the detected amount of movement to the position information retained in the position information buffer 109-2, and the identifier c of the comparison source data, to the data processing section 105B. Reference character S12 denotes the updated position information d′ and the identifier c of the comparison source data. At the time, the generated d′ is saved in the position information buffer 109-2, and moreover, as output S13 of the motion detection processing section 109, a value of 1 indicating that the picture data is continued is outputted. However, if the amount of movement detected by the motion detection processing section 109 is equal to or more than a certain amount, it is determined that a scene change has occurred between the images of two pieces of the picture data, and instead of the amount of movement, the position information d in the data S9 inputted from the pattern comparison processing section 108 is directly outputted as data of output S12 of the motion detection processing section 109, to the data processing section 105B. As the output S13 from the motion detection processing section 109, a value of 0 indicating that the picture data is not continued is outputted.

On the other hand, if there is the input S9 from the pattern comparison processing section 108 to the motion detection processing section 109, any process is not particularly performed, and the position information d in the data S9 inputted from the pattern comparison processing section 108 and the identifier c of the comparison source data are outputted as the data S12 to the data processing section 105B. At the time, the position information d is saved in the position information buffer 109-2, and moreover, as the output S13 of the motion detection processing section 109, the value of 1 indicating that the picture data is continued is outputted.

Here, an operation of the motion detection flag 105B-1 in the data processing section 105B will be described.

The data processing section 105B outputs S8 when 0 has been set to the motion detection flag 105B-1, and does not output S8 if 1 has been set to the motion detection flag 105B-1. Moreover, the pattern comparison processing section 108 does not output S9 if S8 is not inputted. In other words, if 1 has been set to the motion detection flag 105B-1, since S8 (pattern comparison source data) is not inputted to the pattern comparison processing section 108, the pattern comparison is not performed in the pattern comparison processing section 108, and S9 is not transmitted to the motion detection processing section 109. Therefore, the motion detection processing section 109 necessarily outputs S12 based on detection of a motion between the immediately previous picture and the inputted picture. Conversely, if 0 has been set to the motion detection flag 105B-1, since the pattern comparison processing section 108 outputs S9, the motion detection processing section 109 necessarily outputs S12 based on values of S9.

The data processing section 105B retrieves the information a to be displayed on the screen, from within the data obtained in the other TS data S4, based on information on the identifier c in the data S12 inputted from the motion detection processing section 109. The data processing section 105B processes the information a as the appropriate display data by using the position information d or d′ in the data S12 obtained from the motion detection processing section 109, and subsequently outputs the appropriate display data as the display information data S10 to the graphics processing section 106.

The graphics processing section 106 and the output controlling section 107 perform operations similar to those of the first embodiment.

In the second embodiment, if a difference between the picture data is small (that is, in such a case where a scene is continued like video data, and a value of data S13 indicating whether or not continuity exists is outputted as 1), the motion detection processing section 109 detects the amount of movement of the specific object between the picture data, and the data processing section 105B shifts the position of the display data to be displayed by the graphics processing section 106, in accordance with the amount of movement. Thereby, the information can be displayed in accordance with the position of the specific object which moves.

According to the second embodiment, it becomes possible to realize an advantage that the related information is displayed near the specific object, which is obtained in the first embodiment, with a motion detecting process with a relatively light processing burden. Therefore, it becomes unnecessary to perform the pattern matching process with a heavy processing burden for each picture data, which enables to realize a processing system with an easy configuration. It should be noted that, in the first embodiment, since an amount of the shift between the previous screen and the current screen is not detected, it is necessary to perform the pattern matching process for each screen, in sequence from a corner of the screen, with the comparison source data. Therefore, a calculation amount in the processing system is increased, and a heavy burden is imposed.

Therefore, in the second embodiment, when the functions shown in the first embodiment have been implemented, if an image pattern comparing process is slow or the like, it becomes possible to reduce the number of times of image comparison. Thus, even with a configuration with a low processing capability for an image comparing process required for the invention of the first embodiment, it becomes possible to efficiently realize the functions of the first embodiment.

### Third Embodiment

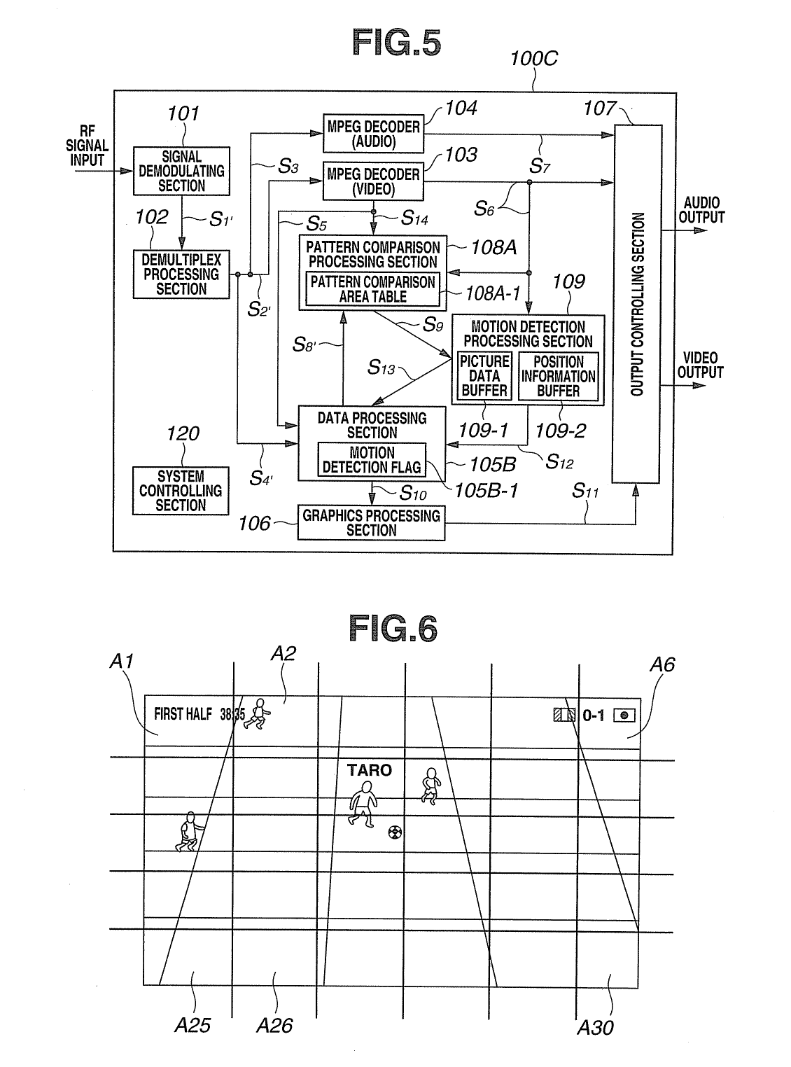

FIG. 5 shows a block diagram of the digital broadcast receiver of a third embodiment of the present invention. FIG. 5 has a configuration in which the pattern comparison processing section of the digital broadcast receiver of the second embodiment of FIG. 4 has been provided with a pattern comparison area table. FIG. 6 shows a state where the screen has been partitioned into lattice-shaped areas of a predetermined size.

In FIG. 5, a digital broadcast receiver 100C has a configuration provided with the signal demodulating section 101, the demultiplex processing section 102, the video MPEG decoder 103 and the audio MPEG decoder 104, the data processing section 105B, the graphics processing section 106, the output controlling section 107, a pattern comparison processing section 108A, the motion detection processing section 109 and the system controlling section 120. Sections with the same functions as the functions of FIG. 1 are attached with the same reference characters.

In a pattern comparison area table 108A-1 to be added, data area_data indicating a processing unit in which the pattern matching is performed for the inputted video data S6 is registered. The data area_data which is registered in the table 108A-1 is data on a position and a size of each lattice area (area partitioned by thick lines in FIG. 6) when a screen size corresponding to the picture data in the video data S6 as shown in FIG. 6 has been partitioned in a lattice pattern in units of a predetermined size, for example, into areas of A1 to A30. The data area_data is included in other TS data S4′ transmitted from the broadcast transmitting side, and retrieved by the data processing section 105B. The data of the comparison source data b and the identifier c thereof in a state of being attached with the data area_data (data S8′) is inputted to the pattern comparison processing section 108A, and the data area_data is stored in the pattern comparison area table 108A-1.

In the case where an area of the screen has been partitioned into A1 to A30 in a lattice pattern as shown in FIG. 6, a format of the data area_data which is registered in the pattern comparison area table 108A-1 becomes as follows.

area_data[i]={(upper left coordinate data, width, height of A1), (upper left coordinate data, width, height of A2), . . . , (upper left coordinate data, width, height of A30)}

i: number designated by flag data in the pattern comparison area table

Moreover, video TS data S2′ of the content broadcasted by the broadcast transmitting side is transmitted in a form in which the video TS data S2′ includes pattern comparison area flag data (S14) in a user data portion defined by MPEG in arbitrary picture data. In other words, the video TS data S2′ is video TS data including the picture data attached with the pattern comparison area flag data (S14) at the user data portion. The pattern comparison area flag data is used for selecting data of each area stored in the pattern comparison area table 108A-1.

In the third embodiment, based on the data S4′ inputted from the demultiplex processing section 102, the data processing section 105B retrieves the data of the display data a, the comparison source data b and the identifier c similarly to the first embodiment, further adds the data area_data in the above described pattern comparison area table thereto, and outputs the data of the display data a, the comparison source data b and the identifier c, and the data area_data, as the data S8′. At the time, the comparison source data b is data of a size depending on the pattern comparison area flag data attached in the data S2′.

When the image pattern comparison is used, the pattern comparison processing section 108A partitions the screen into predetermined areas based on partitioning information from outside included in the other data S4′ separated by the demultiplex processing section 102 which is the data separating section, performs the image pattern comparison in units of the predetermined areas which have been partitioned, and generates the position information on the specific object.

To the pattern comparison processing section 108A, the data S8′ and the pattern comparison area flag data (S14) which is the user data retrieved by the video MPEG decoder 103 are inputted.

If the video data S6 has been inputted to the pattern comparison processing section 108A, the pattern comparison processing section 108A uses data in a table which is selected from each lattice data which has been registered within the pattern comparison area table 108A-1, based on latest pattern comparison area flag data (S14), to perform the pattern matching at an area portion indicated by each lattice data within the table.

Data of a result of the pattern matching process is outputted as output similar to the output of the second embodiment (S9) to the motion detection processing section 109.

The motion detection processing section 109 performs a process similar to the process of the second embodiment, and outputs resultant data S12 and S13 to the data processing section 105B.

Similarly to the second embodiment, the data processing section 105B retrieves the data a to be displayed on the screen, from within the data obtained in the data S4′, based on the information on the identifier c in the data S12 inputted from the motion detection processing section 109. The data processing section 105B processes the data a as the appropriate display data by using the position information d or d′ obtained in the data S12, and subsequently outputs the appropriate display data as the display information data S10 to the graphics processing section 106.

The graphics processing section 106 and the output controlling section 107 perform the operations similar to those of the first embodiment.

It should be noted that although an example in which the third embodiment has been applied to the second embodiment (FIG. 2) is shown, of course, the third embodiment may be applied to the first embodiment (FIG. 1).

According to the third embodiment, the broadcast transmitting side registers and transmits the pattern comparison area flag data indicating data of a pattern comparison area having a size closest to a size of the displayed specific object, in the user data portion in the picture data included in the video data, and transmits the comparison source data of the specific object of a size displayed in a pattern which becomes the comparison source data. Thereby, a size of the area of the image to be compared can be constantly set to an approximately equivalent size.

For example, in the sports relay or the like, whether the target player exists in the zoom out image in which an entire ground is viewed, or the target player is viewed in close-up, the broadcast transmitting side transmits the pattern comparison area flag data and the comparison source data in a size depending on a manner in which the target player is viewed. Thereby, a target to be applied with the pattern matching can be constantly set to an approximately equivalent size.

In other words, when the broadcast transmitting side transmits the data in the pattern comparison area table, if the broadcast transmitting side sets (adjusts) the size of the areas partitioned in a lattice pattern, in accordance with the size of the comparison source data, calculations in the pattern comparing process between an image of each area on the screen and the image of the comparison source data become simple, and thereby the burden on the processing system can be reduced.

Since such a function is added, even if the size of the arbitrary target object within the video data changes significantly depending on whether an image of broadcasted video data is the zoom out image or a close-up image, sizes of target data and the comparison source data to be applied with the pattern matching process constantly become approximately equivalent. Therefore, it is not necessary to perform the pattern matching process in response to the change in the size (a process of changing a difference in size between targets to be compared with each other in the pattern matching process) in the pattern comparison processing section, and the burden associated with the pattern matching process performed by the pattern comparison processing section can be significantly reduced.

On the other hand, in the first and second embodiments, when the image of the video data is changed between the zoom out image and the close-up image, the size of the target data applied with the pattern comparison changes significantly. Therefore, it is necessary to provide a circuit configured to reduce or enlarge the size of the comparison source data and perform the comparison, or it is necessary to transmit the image of the comparison source data in several sets of different sizes, from the broadcast transmitting side.

Thereby, the pattern matching process performed by the pattern comparison processing section can be set so as to have only a function of comparison in the approximately equivalent size, and advantages similar to the advantages obtained in the first and second embodiments can be realized with a simpler function of the pattern comparison processing section.

In the third embodiment, when the functions shown in the first and second embodiments have been implemented, it becomes possible to finely set a range of a processing unit in which the image comparison is performed. Thereby, since the difference in size between the object targeted for the image comparison and the comparison source data becomes small, it becomes possible to make the image comparing process easy and improve precision thereof. Thus, even with the configuration with the low processing capability for the image comparing process required for the invention of the first embodiment, it becomes possible to efficiently realize the finctions of the first embodiment.

### Fourth Embodiment

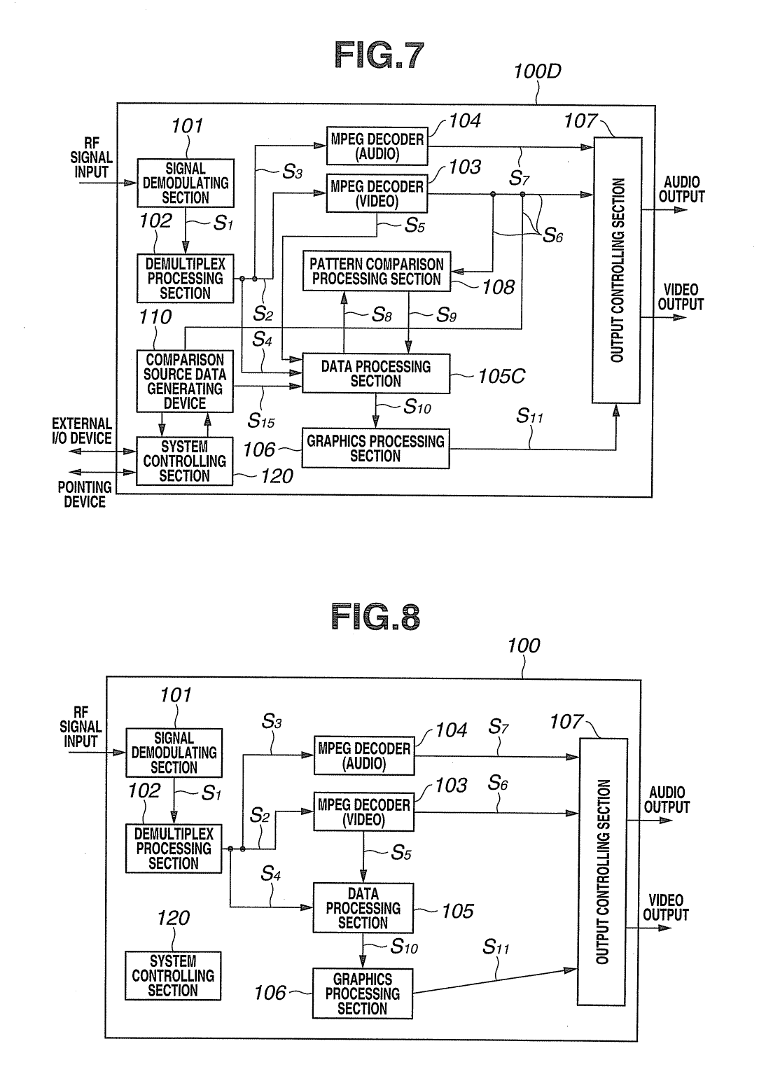

FIG. 7 shows a block diagram of the digital broadcast receiver of a fourth embodiment of the present invention. FIG. 7 has a configuration in which a comparison source data generating device has been added to the digital broadcast receiver of the first embodiment of FIG. 1.

In FIG. 7, a digital broadcast receiver 100D has a configuration provided with the signal demodulating section 101, the demultiplex processing section 102, the video MPEG decoder 103 and the audio MPEG decoder 104, a data processing section 105C, the graphics processing section 106, the output controlling section 107, the pattern comparison processing section 108, a comparison source data generating device 110 and the system controlling section 120. Sections with the same functions as the functions of FIG. 1 are attached with the same reference characters.

The comparison source data generating device 110 uses an external I/O device (for example, an SD card) operated by the system controlling section 120, and captures data corresponding to the other TS data S4 included in the data of the broadcast wave transmitted from the broadcast transmitting side in the first embodiment, from outside of the receiver 100D.

Alternatively, it is possible to capture desired picture data in the video data S6 which is the output of the MPEG decoder 103 in the receiver 100D, as a still image, into the comparison source data generating device 110, designate a desired image range from within the still image with a pointing device (for example, the remote controller) controlled by the system controlling section 120, use the desired image range as the comparison source data b, capture the display data a to be displayed, from the external I/O device, and thereby generate the data corresponding to the other TS data S4 including the display data a and the comparison source data b.

The comparison source data generating device 110 outputs the generated data corresponding to the data S4, to the data processing section 105C.

In the case of the fourth embodiment, the data processing section 105C has a function configured to ignore the other TS data S4 from the demultiplex processing section 102 if there is input from the comparison source data generating device 110.

The fourth embodiment is provided with other functions equivalent to the functions of the first embodiment.

According to the fourth embodiment, when the functions shown in the first embodiment have been implemented, it becomes possible on the user side to freely prepare or generate the comparison source data and the data of the information to be displayed, for the object targeted for the image comparison. As a result, in addition to the advantages of the invention of the first embodiment, it is possible to easily perform information display depending on content viewed by the user and the like, for an object on which special information has not been originally attached in the broadcast, such as displaying information related to the object uniquely by the user.

Having described the embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. A digital broadcast receiver, comprising:
a signal demodulating section configured to receive and demodulate a digital television broadcast signal including stream data having at least video data and other data, the latter of which includes display data to be displayed for a specific object included as an image within the video data and comparison source image data which has been separately prepared for identifying the object;
a data separating section configured to separate the stream data demodulated by the signal demodulating section, into the video data and the other data;
a decoding section configured to decode the video data separated by the data separating section;
a pattern comparison processing section configured to perform pattern comparison between the specific object included as the image in the video data decoded by the decoding section, on a screen, and the comparison source image data included in the other data separated by the data separating section, and thereby generate position information on the specific object on the screen; and
a data processing section configured to use the display data related to the specific object included in the other data separated by the data separating section and the position information generated by the pattern comparison processing section, to output display information data which enables the display data to be displayed in accordance with a position of the specific object on the screen.

2. The digital broadcast receiver according to claim 1, further comprising:
a motion detection processing section configured to input the video data decoded by the decoding section, detect an amount of movement (data on a direction and a distance) of the specific object between on a previous screen and on a current screen, generate new position information in which the amount of movement has been added to the position information on the specific object on the previous screen, and supply the new position information to the data processing section.

3. The digital broadcast receiver according to claim 1, wherein:
when image pattern comparison is used, the pattern comparison processing section partitions the screen into predetermined areas based on partitioning information from outside included in the other data separated by the data separating section, performs the image pattern comparison in units of the predetermined areas which have been partitioned, and generates the position information on the specific object.

4. The digital broadcast receiver according to claim 1, further comprising:
a comparison source data generating device configured to capture data corresponding to the comparison source image data from an externally connectable device.

5. The digital broadcast receiver according to claim 1, further comprising:
a comparison source data generating device configured to generate data corresponding to the comparison source image data by clipping a specific portion from a reproduced screen based on the video data decoded by the decoding section, with a pointing device.

6. The digital broadcast receiver according to claim 1, wherein:
the data processing section inputs the other data separated by the data separating section, analyzes whether or not the comparison source image data for identifying the specific object is included in the other data, and if the comparison source image data for identifying the specific object is included in the other data, generates the comparison source image data and an identifier which indicates that a condition for the comparison source image data has been satisfied and which can be linked to the display data, and registers the comparison source image data and the identifier in the pattern comparison processing section; and
the pattern comparison processing section captures a picture of the video data decoded by the decoding section, as input, performs a pattern matching process within an image of the picture data, with the registered comparison source image data, and if a matching object has existed within the image of the picture data, returns position information indicating a coordinate position at which data matching the identifier of matched comparison source image data exists within the picture data, along with the identifier of the comparison source image data, to the data processing section.

7. The digital broadcast receiver according to claim 6, wherein:
the data processing section retrieves the display data to be displayed on the screen, from within data obtained in the other data, based on information on the identifier obtained in the pattern comparison processing section, processes the display data as appropriate display data by using the position information obtained in the pattern comparison processing section, and subsequently outputs the appropriate display data as the display information data.

8. The digital broadcast receiver according to claim 6, wherein:
the comparison source image data includes multiple pieces of characteristic data for identifying the specific object, and if a predetermined number, which has been previously defined, of the multiple pieces of characteristic data matches characteristics of an object to be identified, the object to be identified is regarded as an intended object which has satisfied a necessary identification condition, and the identifier which represents that the identification condition has been satisfied and which can be linked to the display data is generated.

9. The digital broadcast receiver according to claim 8, wherein:
multiple identification conditions for generating the identifier are prepared, and which identification condition is used can be selected.

10. The digital broadcast receiver according to claim 8, wherein:
the comparison source image data includes the multiple pieces of characteristic data for identifying the specific object, and if the specific object to be identified is a person, image data of the same person in multiple poses (postures) is prepared as the characteristic data.

11. The digital broadcast receiver according to claim 2, wherein:
the data processing section includes a motion detection flag therein, and while the flag is 0, from the other data which is inputted, the data processing section generates output which is the comparison source image data and an identifier thereof, and outputs the output to the pattern comparison processing section, and while the flag is 1, the data processing section does not output the comparison source image data and the identifier thereof;
in the pattern comparison processing section, the comparison source image data and the identifier thereof are inputted, the identifier is registered, and the generated position information and the identifier of the comparison source image data are outputted to the motion detection processing section; and
the motion detection processing section includes a buffer for picture data in the video data decoded by the decoding section, and a position information buffer, retains picture data which has been inputted immediately before, in the picture data buffer, and retains the position information for the immediately previous picture data, in the position information buffer.

12. The digital broadcast receiver according to claim 2, wherein:
the motion detection processing section detects the amount of movement of the specific object between picture data, and if the amount of movement detected by the motion detection processing section is small, it is determined that a scene is continued between images of two pieces of the picture data, and the data processing section shifts a position of the display data in accordance with the amount of movement, and thereby enables the display data to be displayed in accordance with the position of the specific object which moves; and
if the amount of movement detected by the motion detection processing section is equal to or more than a certain amount, it is determined that a scene change has occurred between the images of the two pieces of the picture data, and instead of the amount of movement, the position information in data inputted from the pattern comparison processing section is directly outputted as data of output of the motion detection processing section, to the data processing section.

13. The digital broadcast receiver according to claim 3, wherein:
the pattern comparison processing section includes a pattern comparison area table, and if the video data has been inputted to the pattern comparison processing section, the pattern comparison processing section uses data in a table which is selected from each lattice data which has been registered within the pattern comparison area table, based on latest pattern comparison area flag data, to perform pattern matching at an area portion indicated by each lattice data within the table, and outputs a result of a process of the pattern matching, as the position information and an identifier of the comparison source image data, to the motion detection processing section;
the motion detection processing section outputs the position information before or after being updated, the identifier of the comparison source image data, and information indicating whether or not picture data is continued, as data, to the data processing section; and
the data processing section retrieves the display data to be displayed on the screen, from within data obtained in the data separating section, based on information on the identifier inputted from the motion detection processing section, processes the display data as appropriate display data by using the position information or the position information after being updated, which are inputted from the motion detection processing section, and subsequently outputs the appropriate display data as the display information data.
